(19) United States
(12) Patent Application Publication
(10) Pub. No.: US 2011/0093658 A1
(43) Pub. Date: Apr. 21, 2011

(54) CLASSIFYING AND SEGREGATING BRANCH TARGETS

(76) Inventors: Gerald D. Zuraski, JR., Austin, TX (US); James D. Dundas, Austin, TX (US); Anthony X. Jarvis, Acton, MA (US)

(21) Appl. No.: 12/581,878

(22) Filed: Oct. 19, 2009

(51) Int. Cl. G06F 9/38; G06F 12/08

(52) U.S. Cl. 711/125; 712/239; 712/E09.045; 711/E12.017

(57) ABSTRACT

A system and method for branch prediction in a microprocessor. A branch prediction unit stores an indication of a location of a branch target instruction relative to its corresponding branch instruction. For example, a target instruction may be located within a first region of memory as a branch instruction. Alternatively, the target instruction may be located outside the first region, but within a larger second region. The prediction unit comprises a branch target array corresponding to each region. Each array stores a bit range of a branch target address, wherein the stored bit range is based upon the location of the target instruction relative to the branch instruction. The prediction unit constructs a predicted branch target address by concatenating a bits stored in the branch target arrays.

### BACKGROUND OF THE INVENTION

1. Field of the Invention

This invention relates to microprocessors, and more particularly, to branch prediction mechanisms.

2. Description of the Relevant Art

Modern microprocessors may include one or more processor cores, or processors, wherein each processor is capable of executing instructions of a software application. These processors are typically pipelined. Although the pipeline may be divided into any number of stages at which portions of instruction processing are performed, instruction processing generally comprises fetching the instruction, decoding the instruction, executing the instruction, and storing the execution results in the destination identified by the instruction.

Ideally, every clock cycle produces useful execution of an instruction for each stage of a pipeline. However, a stall in a pipeline may cause no useful work to be performed during that particular pipeline stage. Some stalls may last several clock cycles and significantly decrease processor performance. One example of a possible multi-cycle stall is a calculation of a branch target address for a branch instruction.

Overlapping pipeline stages may reduce the negative effect of stalls on processor performance. A further technique is to allow out-of-order execution of instructions, which helps reduce data dependent stalls. In addition, a core with a superscalar architecture issues a varying number of instructions per clock cycle based on dynamic scheduling. However, a stall of several clock cycles still reduces the performance of the processor due to in-order retirement that may prevent hiding of all the stall cycles. Therefore, another method to reduce performance loss is to reduce the occurrence of multi-cycle stalls. One such multi-cycle stall is a calculation of a branch target address for a branch instruction.

Modern microprocessors may need multiple clock cycles to both determine the outcome of a condition of a conditional branch instruction and to determine the branch target address of a taken conditional branch instruction. For a particular thread being executed in a particular pipeline, no useful work may be performed by the branch instruction or subsequent instructions until the branch instruction is decoded and later both the condition outcome is known and the branch target address is known. These stall cycles decrease the processor's performance.

Rather than stall, predictions may be made of the conditional branch condition and the branch target address shortly after the instruction is fetched. The exact stage as to when the prediction is ready is dependent on the pipeline implementation. When one or more instructions are being fetched during a fetch pipeline stage, the processor may determine or predict for each instruction if it is a branch instruction, if a conditional branch instruction is taken, and what is the branch target address for a taken direct conditional branch instruction. If these determinations are made, then the processor may initiate the next instruction access as soon as the previous access is complete.

A branch target buffer (BTB) may be used to predict a path of a branch instruction and to store, or cache, information corresponding to the branch instruction. The BTB may be accessed during a fetch pipeline stage. The design of a BTB attempts to achieve maximum system performance with a limited number of bits allocated to the BTB. Typically, each entry of a BTB stores status information, a branch tag, branch prediction information, a branch target address, and instruction bytes found at the location of the branch target address. These fields may be separated into disjoint arrays or tables. For example, the branch prediction information may be stored in a pattern history table. The branch target address may be stored in a branch target array.

Typically, the entire branch target address is stored in a branch target array. For most software applications the majority of branch target addresses lie within a same region, such as a 4 KB aligned portion of memory, as the branch instruction. As a result, most of the branch target address bits cached in the branch target array may not be utilized to reconstruct the branch target address. This is a non-optimal use of both on-chip real estate and power consumption of the processor. Consequently, by reducing the size of the branch prediction storage in order to reduce gate area and power consumption, valuable data regarding the target address of a branch may be evicted and may be recreated at a later time. Also, if less bits of the target address are cached, it may not be known for each branch instruction, the actual number of bits to keep. For example, an application still has branches with target addresses outside a 4 KB aligned region of memory.

In view of the above, efficient methods and mechanisms for branch target address prediction capability that may not require a significant increase in the gate count or size of the branch prediction mechanism are desired.

### SUMMARY OF THE INVENTION

Systems and methods for branch prediction in a microprocessor are contemplated. In one embodiment, a branch prediction unit with multiple branch target arrays within a microprocessor is provided. Each entry of a given branch target array stores a portion of a branch target address corresponding to a branch linear address used to index the entry. The portion, or bit range, to be stored is based upon the given branch target array relative to others of the plurality of branch target arrays. For example, a first branch target array may store a least-significant first number of bits of a branch target address. A second branch target array may store a more-significant second number of bits of the branch target address contiguous with the first number of bits within the branch target address.

The prediction unit may store an indication of a location within memory of a branch target instruction relative and corresponding to the branch instruction. For example, the indication may identify the branch target instruction is located within a first region, such as an aligned 4 KB page, relative to the branch instruction. A first value, such as a binary value b′00, of this indication may identify the branch target instruction is located within the first region. An nth value of this stored indication may identify the branch target instruction is located outside an (n-1)th region but within a larger nth region. A first branch target array may store portions of target addresses corresponding to branch target instructions located within the first region. An nth branch target array may store portions of target addresses corresponding to branch target instructions located outside the (n-1)th region but within the larger nth region.

The prediction unit may construct a predicted branch target address by concatenating a more-significant portion of the branch linear address with each stored portion of a branch target array from the first branch target array to an nth branch target array, wherein the branch target instruction is not located outside the nth region as identified by the stored indication.

### BRIEF DESCRIPTION OF THE DRAWINGS

FIG. 1 is a generalized block diagram of one embodiment of a processor core.

FIG. 2 is a generalized block diagram illustrating one embodiment of an i-cache storage arrangement.

FIG. 3 is a generalized block diagram illustrating one embodiment of a branch prediction unit.

FIG. 4 is a generalized block diagram illustrating one embodiment of instruction placements within a memory.

FIG. 5 is a generalized block diagram illustrating one embodiment of a branch prediction unit with multiple branch target arrays.

FIG. 6 is a generalized block diagram illustrating one embodiment of a processor core with hybrid branch prediction.

FIG. 7 is a generalized block diagram illustrating one embodiment of a sparse cache storage arrangement.

FIG. 8 is a generalized block diagram illustrating one embodiment of a branch prediction unit.

FIG. 9 is a flow diagram of one embodiment of a method for efficient branch prediction.

FIG. 10 is a flow diagram of one embodiment of a method for continuing efficient branch prediction.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

In the following description, numerous specific details are set forth to provide a thorough understanding of the present invention. However, one having ordinary skill in the art should recognize that the invention may be practiced without these specific details. In some instances, well-known circuits, structures, and techniques have not been shown in detail to avoid obscuring the present invention.

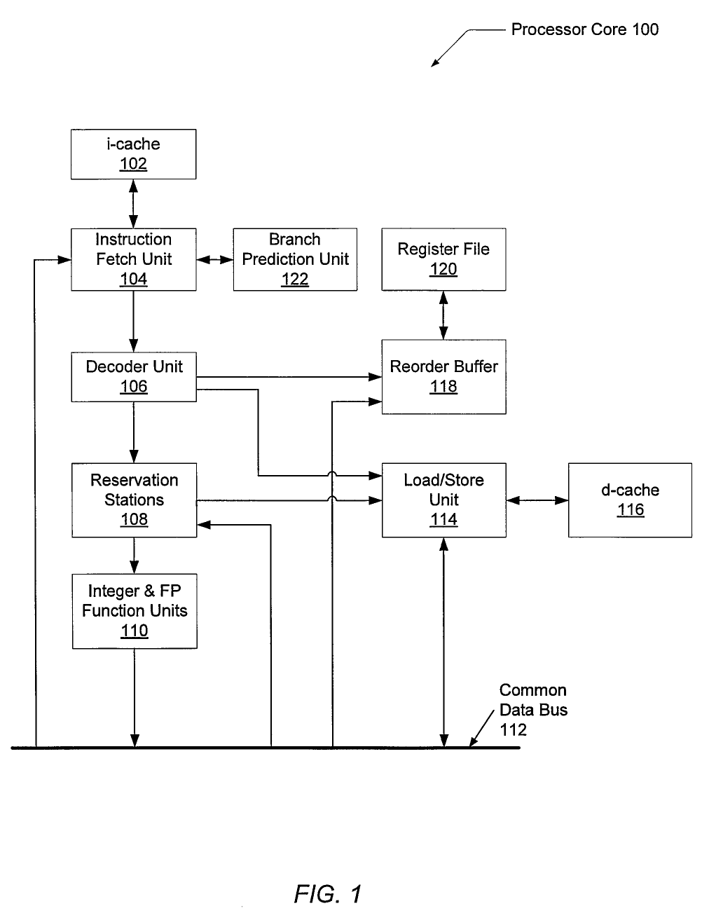

Referring to FIG. 1, one embodiment of a generalized block diagram of a processor or processor core 100 that performs out-of-order execution is shown. Core 100 includes circuitry for executing instructions according to a predefined instruction set architecture (ISA). For example, the x86 instruction set architecture may be selected. Alternatively, any other instruction set architecture may be selected. In one embodiment, core 100 may be included in a single-processor configuration. In another embodiment, core 100 may be included in a multi-processor configuration. In other embodiments, core 100 may be included in a multi-core configuration within a processing node of a multi-node system. Processor core 100 may be embodied in a central processing unit (CPU), a graphics processing unit (GPU), digital signal processor (DSP), combinations thereof or the like

An instruction-cache (i-cache) 102 may store instructions for a software application and a data-cache (d-cache) 116 may store data used in computations performed by the instructions. Generally speaking, a cache may store one or more blocks, each of which is a copy of data stored at a corresponding address in the system memory, which is not shown. As used herein, a “block” is a set of bytes stored in contiguous memory locations, which are treated as a unit for coherency purposes. In some embodiments, a block may also be the unit of allocation and deallocation in a cache. The number of bytes in a block may be varied according to design choice, and may be of any size. As an example, 32 byte and 64 byte blocks are often used.

Caches 102 and 116, as shown, may be integrated within processor core 100. Alternatively, caches 102 and 116 may be coupled to core 100 in a backside cache configuration or an inline configuration, as desired. Still further, caches 102 and 116 may be implemented as a hierarchy of caches. In one embodiment, caches 102 and 116 each represent L1 and L2 cache structures. In another embodiment, caches 102 and 116 may share another cache (not shown) implemented as an L3 cache structure. Alternatively, each of caches 102 and 116 each represent an L1 cache structure and a shared cache structure may be an L2 cache structure. Other combinations are possible and may be chosen, if desired.

Caches 102 and 116 and any shared caches may each include a cache memory coupled to a corresponding cache controller. If core 100 is included in a multi-core system, a memory controller (not shown) may be used for routing packets, receiving packets for data processing, and synchronize the packets to an internal clock used by logic within core 100. Also, in a multi-core system, multiple copies of a memory block may exist in multiple caches of multiple processors. Accordingly, a cache coherency circuit may be included in the memory controller. Since a given block may be stored in one or more caches, and further since one of the cached copies may be modified with respect to the copy in the memory system, computing systems often maintain coherency between the caches and the memory system. Coherency is maintained if an update to a block is reflected by other cache copies of the block according to a predefined coherency protocol. Various specific coherency protocols are well known.

The instruction fetch unit (IFU) 104 may fetch multiple instructions from the i-cache 102 per clock cycle if there are no i-cache misses. The IFU 104 may include a program counter (PC) register that holds a pointer to an address of the next instructions to fetch from the i-cache 102. A branch prediction unit 122 may be coupled to the IFU 104. Unit 122 may be configured to predict information of instructions that change the flow of an instruction stream from executing a next sequential instruction. An example of prediction information may include a 1-bit value comprising a prediction of whether or not a condition is satisfied that determines if a next sequential instruction should be executed or an instruction in another location in the instruction stream should be executed next. Another example of prediction information may be an address of a next instruction to execute that differs from the next sequential instruction. The determination of the actual outcome and whether or not the prediction was correct may occur in a later pipeline stage. Also, in an alternative embodiment, IFU 104 may comprise unit 122, rather than have the two be implemented as two separate units.

Branch instructions comprise different types such as conditional, unconditional, direct, and indirect. A conditional branch instruction performs a determination of which path to take in an instruction stream. If the branch instruction determines a specified condition, which may be encoded within the instruction, is not satisfied, then the branch instruction is considered to be not-taken and the next sequential instruction in a program order is executed. However, if the branch instruction determines a specified condition is satisfied, then the branch instruction is considered to be taken. Accordingly, a subsequent instruction, which is not the next sequential instruction in program order, but rather is an instruction located at a branch target address, is executed. An unconditional branch instruction is considered an always-taken conditional branch instruction. There is no specified condition within the instruction to test, and execution of subsequent instructions always occurs in a different sequence than sequential order.

A branch target address may be specified by an offset, which may be stored in the branch instruction itself, relative to the linear address value stored in the program counter (PC) register. This type of branch instruction with a self-specified branch target address is referred to as direct. A branch target address may also be specified by a value in a register or memory, wherein the register or memory location may be stored in the branch instruction. This type of branch instruction with an indirect-specified branch target address is referred to as indirect. Further, in an indirect branch instruction, the register specifying the branch target address may be loaded with different values.

Examples of unconditional indirect branch instructions include procedure calls and returns that may be used for implementing subroutines in program code, and that may use a Return Address Stack (RAS) to supply the branch target address. Another example is an indirect jump instruction that may be used to implement a switch-case statement, which is popular in object-oriented programs such as C++ and Java.

An example of a conditional branch instruction is a branch instruction that may be used to implement loops in program code (e.g. “for” and “while” loop constructs). Conditional branch instructions must satisfy a specified condition to be considered taken. An example of a satisfied condition may be a specified register now holds a stored value of zero. The specified register is encoded in the conditional branch instruction. This specified register may have its stored value decrementing in a loop due to instructions within software application code. The output of the specified register may be input to dedicated zero detect combinatorial logic.

In addition, conditional branch instructions may have some dependency on one another. For example, a program may have a simple case such as:
if (value==0) value==1;
if (value==1)

The conditional branch instructions that will be used to implement the above case will have global history that may be used to improve the accuracy of predicting the conditions. In one embodiment, the prediction may be implemented by 2-bit counters. Branch prediction is described in more detail next.

In order to predict a branch condition, the PC used to fetch the instruction from memory, such as from an instruction cache (i-cache), may be used to index branch prediction logic. One example of an early combined prediction scheme that uses the PC is the gselect branch prediction method described in Scott McFarling's 1993 paper, “Combining Branch Predictors”, Digital Western Research Laboratory Technical Note TN-36, incorporated herein by reference in its entirety. The linear address stored in the PC may be combined with values stored in a global history register. The combined values may then be used to index prediction tables such as a pattern history table (PHT), a branch target buffer (BTB), or otherwise. The update of the global history register with branch target address information of a current branch instruction, rather than a taken or not-taken prediction, may increase the prediction accuracy of both conditional branch direction predictions (i.e. taken and not-taken outcome predictions) and indirect branch target address predictions, such as a BTB prediction or an indirect target array prediction. Many different schemes may be included in various embodiments of branch prediction mechanisms.

High branch prediction accuracy contributes to more power-efficient and higher performance microprocessors. Therefore, taking a BTB as an example, the design of a BTB attempts to achieve maximum system performance with a limited number of bits allocated to the BTB. Instructions from the predicted instruction stream may be speculatively executed prior to execution of the branch instruction, and in any case are placed into a processor's pipeline prior to execution of the branch instruction. If the predicted instruction stream is correct, then the number of instructions executed per clock cycle is advantageously increased. However, if the predicted instruction stream is incorrect (i.e. one or more branch instructions are predicted incorrectly such as the condition or the branch target address), then the instructions from the incorrectly predicted instruction stream are discarded from the pipeline and the number of instructions executed per clock cycle is decreased.

Frequently, branch prediction mechanism comprises a history of prior executions of a branch instruction in order to form a more accurate behavior for the particular branch instruction. Such a branch prediction history typically requires maintaining data corresponding to the branch instruction in a storage. Also, a branch target buffer (BTB) or an accompanying branch target array may be used to store branch target addresses used in target address predictions. In the event the branch prediction data comprising history and address information are evicted from the storage, or otherwise lost, it may be necessary to recreate the data for the branch instruction at a later time.

The decoder unit 106 decodes the opcodes of the multiple fetched instructions. Decoder unit 106 may allocate entries in an in-order retirement queue, such as reorder buffer 118, in reservation stations 108, and in a load/store unit 114. The allocation of entries in the reservation stations 108 is considered dispatch. The reservation stations 108 may act as an instruction queue where instructions wait until their operands become available. When operands are available and hardware resources are also available, an instruction may be issued out-of-order from the reservation stations 108 to the integer and floating point functional units 110 or the load/store unit 114. The functional units 110 may include arithmetic logic units (ALU's) for computational calculations such as addition, subtraction, multiplication, division, and square root. Logic may be included to determine an outcome of a branch instruction and to compare the calculated outcome with the predicted value. If there is not a match, a misprediction occurred, and the subsequent instructions after the branch instruction need to be removed and a new fetch with the correct PC value needs to be performed.

The load/store unit 114 may include queues and logic to execute a memory access instruction. Also, verification logic may reside in the load/store unit 114 to ensure a load instruction received forwarded data, or bypass data, from the correct youngest store instruction.

Results from the functional units 110 and the load/store unit 114 may be presented on a common data bus 112. The results may be sent to the reorder buffer 118.

Here, an instruction that receives its results, is marked for retirement, and is head-of-the-queue may have its results sent to the register file 120. The register file 120 may hold the architectural state of the general-purpose registers of processor core 100. In one embodiment, register file 120 may contain 32 32-bit registers. Then the instruction in the reorder buffer may be retired in-order and its head-of-queue pointer may be adjusted to the subsequent instruction in program order.

The results on the common data bus 112 may be sent to the reservation stations in order to forward values to operands of instructions waiting for the results. When these waiting instructions have values for their operands and hardware resources are available to execute the instructions, they may be issued out-of-order from the reservation stations 108 to the appropriate resources in the functional units 110 or the load/store unit 114. Results on the common data bus 112 may be routed to the IFU 104 and unit 122 in order to update control flow prediction information and/or the PC value.

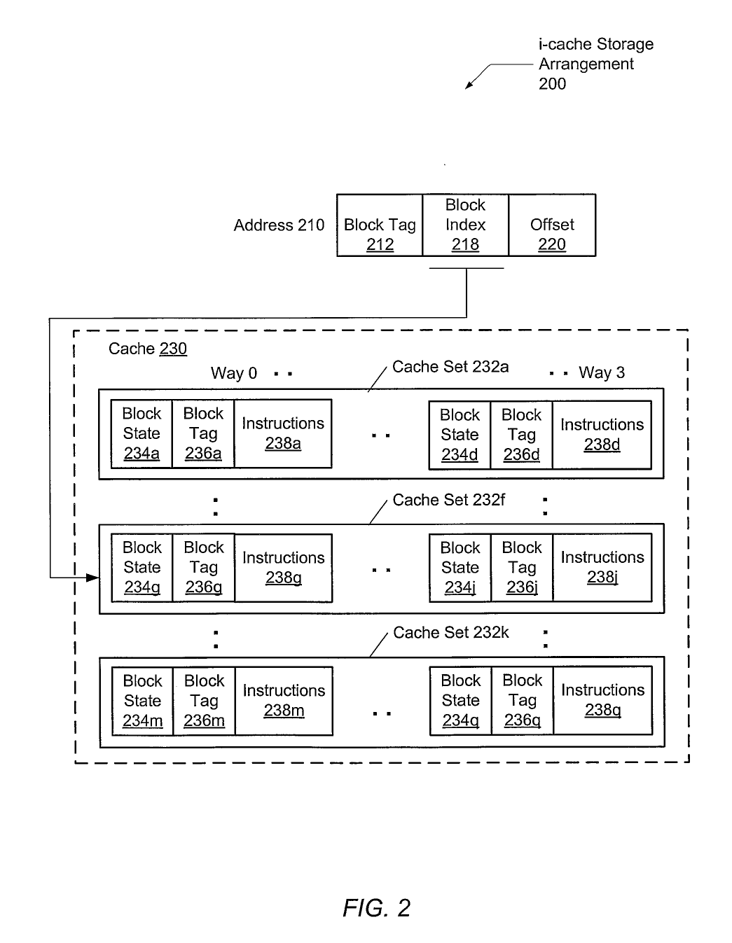

Software application instructions may be stored within an instruction cache, such as i-cache 102 of FIG. 1 in various manners. For example, FIG. 2 illustrates one embodiment of an i-cache storage arrangement 200 in which instructions are stored using a 4-way set-associative cache organization. Instructions 238, which may be variable-length instructions depending on the ISA, may be the data portion or block data of a cache line within 4-way set associative cache 230. In one embodiment, instructions 238 of a cache line may comprise 64 bytes. In an alternate embodiment, a different size may be chosen.

The instructions that may be stored in the contiguous bytes of instructions 238 may include one or more branch instructions. Some cache lines may have only a few branch instructions and other cache lines may have several branch instructions. The number of branch instructions per cache line is not consistent. Therefore, a storage of branch prediction information for a corresponding cache line may need to assume a high number of branch instructions are stored within the cache line in order to provide information for all branches.

Each of the 4 ways of cache 230 also has state information 234, which may comprise a valid bit and other state information of the cache line. For example, a state field may include encoded bits used to identify the state of a corresponding cache block, such as states within a MOESI scheme. Additionally, a field within block state 234 may include bits used to indicate Least Recently Used (LRU) information for an eviction. LRU information may be used to indicate which entry in the cache set 232 has been least recently referenced, and may be used in association with a cache replacement algorithm employed by a cache controller.

An address 210 presented to the cache 230 from a processor core may include a block index 218 in order to select a corresponding cache set 232. In one embodiment, block state 234 and block tag 236 may be stored in a separate array, rather than in contiguous bits within a same array. Block tag 236 may be used to determine which of the 4 cache lines are being accessed within a chosen cache set 232. In addition, offset 220 of address 210 may be used to indicate a specific byte or word within a cache line.

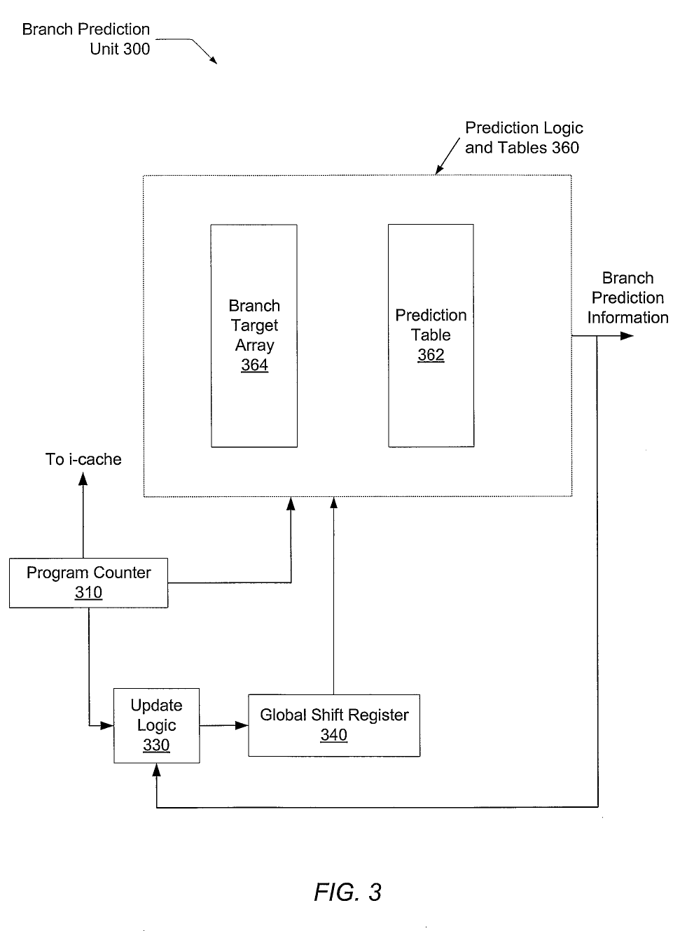

FIG. 3 illustrates one embodiment of a branch prediction unit 300. In one embodiment, the address of an instruction is stored in the register program counter 310 (PC 310). In one embodiment, the address may be a 32-bit or a 64-bit value. A global history shift register 340 (GSR 340) may contain a recent history of the prediction results of a last number of conditional branch instructions. In one embodiment, GSR 340 may be a one-entry register comprising a predetermined number of bits.

The information stored in GSR 340 may be used to predict whether or not a condition is satisfied of a current conditional branch instruction by using global history. For example, in one embodiment, GSR 340 may be an N shift register that holds the 1-bit taken/not-taken results of the last N conditional branch instructions in program execution. In one embodiment, a logic “1” may indicate a taken outcome and a logic “0” may indicate a not-taken outcome, or vice-versa. Additionally, in alternative embodiments, GSR 340 may use information corresponding to a per-branch basis or to a combined-branch history within a table of branch histories. One or more branch history tables (BHTs) may be used in these embodiments to provide global history information to be used to make branch predictions.

If enough address bits (i.e. the PC of the current branch instruction stored in PC 310) are used to identify the current branch instruction, a hashing of these bits with the global history stored in GSR 340 may have more useful prediction information than either component alone. In one embodiment, selected low-order bits of the PC may be hashed with selected bits of the GSR. In alternate embodiments, bits other than the low-order bits of the PC, and possibly non-consecutive bits, may be used with the bits of the GSR. Also, multiple portions of the GSR 340 may be separately used with PC 310. Numerous such alternatives are possible and are contemplated.

In one embodiment, hashing of the PC bits and the GSR bits may comprise concatenation of the bits. In one embodiment, the PC alone may be used to index BTBs in prediction logic 360. As used herein, elements referred to by a reference numeral followed by a letter may be collectively referred to by the numeral alone.

In the embodiment shown, each entry within a single branch target array 364 may store a branch target address corresponding to an entry within a BTB configured to store at least a branch tag, branch prediction information, and instruction bytes found at the location of the branch target address. Alternatively, one or more of these fields may be stored in another prediction table 362 rather than a single BTB. In one embodiment, branch target array 364 stores predicted branch target addresses of conditional branch instructions. In another embodiment, branch target array 364 stores both predicted branch target addresses of conditional direct branch instructions and indirect branch target address predictions.

In one embodiment, each entry of the single branch target array 364 stores an entire branch target address. This storage of an entire branch target address in each entry may be a non-optimal use of both on-chip real estate and power consumption of the processor. For most software applications the majority of branch target instructions referenced by corresponding branch target addresses lie within a same region, such as a 4 KB aligned page of memory, as the branch instruction.

In one embodiment, one prediction table 362 may be a PHT for conditional branches, wherein each entry of the PHT may hold a 2-bit counter. A particular 2-bit counter may be incremented and decremented based on past behavior of the conditional branch instruction result (i.e. taken or not-taken). Once a predetermined threshold value is reached, the stored prediction may flip between a 1-bit prediction value of taken and not-taken. In a 2-bit counter scenario, each entry of the PHT may hold one of the following four states in which each state corresponds to 1-bit taken/not-taken prediction value: predict strongly not-taken, predict not-taken, predict strongly taken, and predict taken.

Once a prediction (e.g. taken/not-taken or branch target address or both) is determined, its value may be shifted into the GSR 340 speculatively. In one embodiment, only a taken/not-taken value is shifted into GSR 340. In other embodiments, a portion of the branch target address is shifted into GSR 340. A determination of how to update GSR 340 is performed in update logic 320. In the event of a misprediction determined in a later pipeline stage, this value(s) may be repaired with the correct outcome. However, this process also incorporates terminating the instructions fetched due to the branch misprediction that are currently in flight in the pipeline and re-fetching instructions from the correct PC.

In one embodiment, the 1-bit taken/not-taken prediction from a PHT or other logic in prediction logic and tables 360 may be used to determine the next PC to use to index an i-cache, and simultaneously to update the GSR 340. For example, in one embodiment, if the prediction is taken, the predicted branch target address read from the branch target array 364 may be used to determine the next PC. If the prediction is not-taken, the next sequential PC may be used to determine the next PC.

In one embodiment, update logic 320 may determine the manner in which GSR 340 is updated. For example, in the case of conditional branches requiring a global history update, update logic 330 may determine to shift the 1-bit taken/not-taken prediction bit into the most-recent position of GSR 340. In an alternate embodiment, a branch may not provide a value for the GSR.

In each implementation of update logic 330, the new global history stored in GSR 340 may increase the accuracy of conditional branch direction predictions (i.e.

taken/not-taken outcome predictions). The accuracy improvements may be reached with negligible impact on die-area, power consumption, and clock cycle increase.

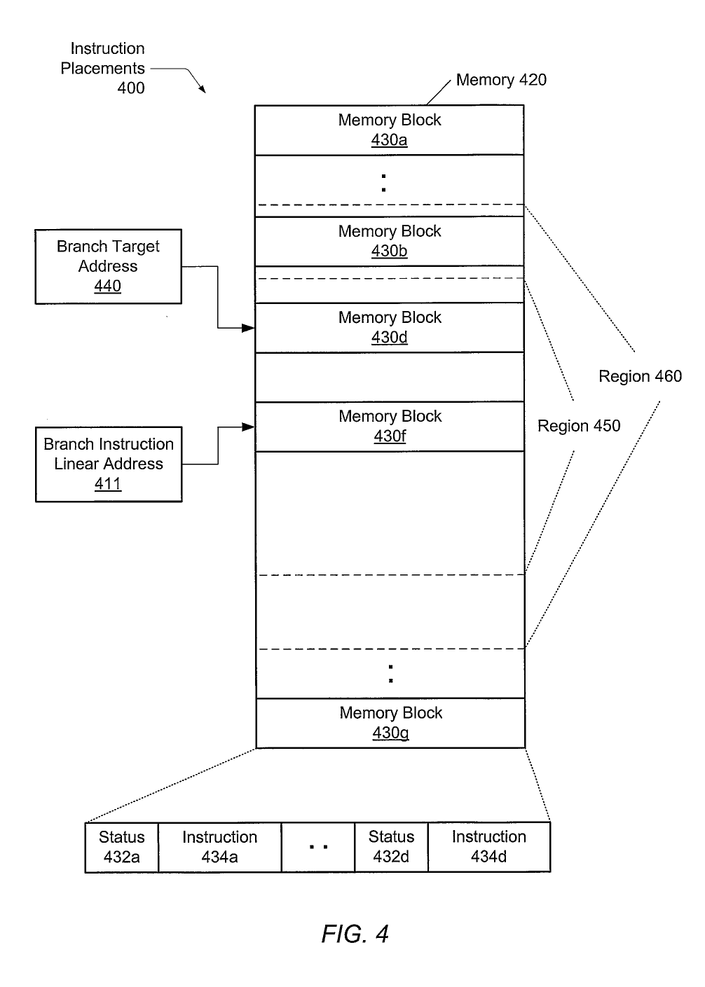

Turning now to FIG. 4, one embodiment of instruction placements 400 is shown. Memory 420 may be coupled to one or more microprocessors 100 and corresponding higher-level caches, via one or more memory controllers. All or a portion of memory 420 may be used to store instructions of software applications to be executed on the one or more microprocessors 100. Memory 420 may comprise one or more dynamic random access memories (DRAMs), synchronous DRAMs (SDRAMs), DRAM, static RAM, a hard disk, etc. The width of memory 420 may be referred to as an aggregate data size.

Memory block 430 is shown for illustrative purposes and is aligned to the width of memory 420. In one embodiment, the size of memory block 430 is 8 bytes. In alternative embodiments, different sizes may be chosen.

When storing instructions of software applications, a memory block 430 may comprise one or more instructions 434 with accompanying status information 432 such as a valid bit and other information similar to state information stored in block state 234 described above. Although the fields in memory blocks 430 are shown in this particular order, other combinations are possible and other or additional fields may be utilized as well. The bits storing information for the fields 432 and 434 may or may not be contiguous.

In one example, a direct branch instruction may be located in memory block 430f. This location may be referenced by a branch instruction linear address 411. An instruction corresponding to the branch target of the direct branch instruction may be located in memory block 430d. A branch target address 440 may reference this location. Memory block 430d may be located within a same region 450 as the branch instruction located in memory block 430f. In one embodiment, region 450 corresponds to a 4 KB aligned page of memory.

In one embodiment, for a given software application, the majority of branch target instructions are located within a same region, such as region 450, as the corresponding branch instruction. An example is a branch target instruction located in memory block 430d. For the same given software application, a smaller percentage of the branch target instructions may be located outside of region 450, but within a second larger region, such as region 460 shown in FIG. 4. An example is a branch target instruction located in memory block 430b. An even smaller percentage, possibly negligible, of the branch target instructions may be located outside of the second larger region, such as region 460. An example is a branch target instruction located in memory block 430a. Therefore, the majority of the bits of the branch target address 440 may have the same value as the corresponding bit positions in the branch instruction linear address 411.

In one example, for a given 48-bit branch instruction linear address 411, only the lower 12 bits, such as bit positions 11:0, used to reference a particular byte within a 4 KB page region, such as region 450, may be unique from the majority of branch target addresses 440 utilized by a given software application. In other words, for a majority of cases, the upper 36 bits, such as bit positions 47:12, of a branch target address 440 have a same value as the corresponding bit positions 47:12 of the branch instruction linear address 411.

If the percentage of branch target instructions located within a same region as the corresponding branch instructions is greater than a predetermined high threshold, then it may be unnecessary to store the upper 36 bits of the branch target address 440 in a branch target array 364. Rather, these 36 bits may be determined from the provided branch linear address 411. Therefore, the branch target array 364 may store more branch target addresses for a same array size. Likewise, the branch target array 364 may store a same number of branch target addresses but with a much smaller array size.

Although the percentage value described above may be high, it may still differ sufficiently from 100% such that the cost of mispredicting branch target addresses 440 significantly reduces the benefit of storing only a small subset of the branch target addresses 440 in the branch target array 364. However, a second percentage value corresponding to a second larger region, such as region 460, may differ only slightly from 100%. In one example, nearly 100% of branch target instructions may be located within region 460 of a corresponding branch instruction. In this example, the lower 28 bits of the branch linear address 411 may correspond to the size of region 460. However, rather than store the bit positions 27:0 in the branch target array 364, a second array may be utilized.

Continuing with this example, a first array may store the bit positions 11:0 of a branch target address 410 for a majority of the cases wherein the branch target instruction is located within a smaller region 450 as the corresponding branch instruction. A second array may store the bit positions 27:12 of a branch target address 410 for the cases wherein the branch target instruction is located within a larger region 460 as the corresponding branch instruction.

The number of branch target instructions located outside of smaller region 450 but within larger region 460 may be less than the number of branch target instructions located within smaller region 450. Yet, the total number of branch target addresses 410 stored by both the first and second arrays may cover nearly 100% of all branch instructions within the given software application. In this example, only two regions are described. In other examples, a third region may be utilized. In yet other examples, a fourth region may additionally be utilized and so forth.

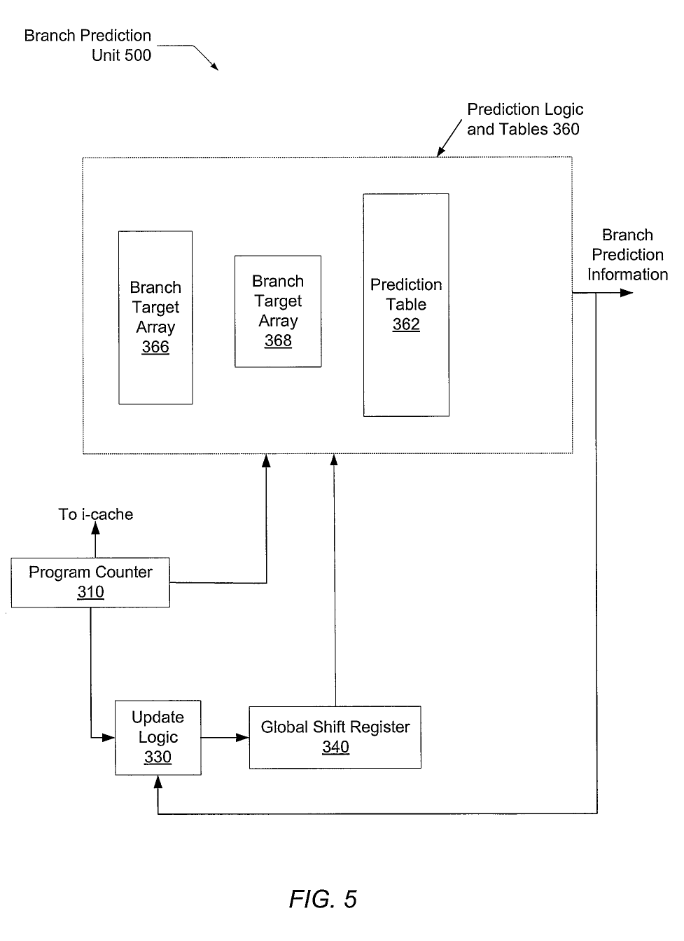

Referring now to FIG. 5, one embodiment of a branch prediction unit 500 with multiple branch target arrays is shown. Components corresponding to circuitry already described regarding branch prediction unit 300 are numbered accordingly. In one embodiment, a single branch target array 364 may be replaced with two branch target arrays 366 and 368. Each entry of branch target array 366 may be configured to store a small portion of an entire branch target addresses 440. In one embodiment, the lower 12 bits, or bit positions 11:0, of a branch target address is stored in an entry. A majority of branch target instructions may be located within an aligned 4 KB page of a corresponding branch instruction. The predicted branch target address 440 may be constructed by concatenating the 12 bits (positions 11:0) stored in a corresponding entry of the branch target array 366 with the upper 36 bits (positions 47:12) of the branch instruction linear address 411.

In one embodiment, the branch target array 368 may be powered down until the branch prediction unit 500 detects a branch target instruction is located out of region 450, corresponding to addresses stored in array 366, but within region 460 corresponding to addresses stored in array 368. It is noted that both branch target arrays 366 and 368 are indexed during this case. This detection and the indexing of arrays 366 and 368 are described shortly below.

Each entry of the branch target array 368 may be configured to store a larger portion, or a larger number of bits, of an entire branch target addresses 440. In one embodiment, the next upper 16 bits, or bit positions 27:12, of a branch target address 440 is stored in an entry. The predicted branch target address may be constructed by concatenating the 12 bits (positions 11:0) stored in a corresponding entry of the branch target array 366 with the 16 bits (positions 27:12) stored in a corresponding entry of the array 368 and with the upper remaining bits (positions 47:28) of the branch instruction linear address.

In one embodiment, arrays 366 and 368 are indexed by a branch instruction linear address 411 stored in the PC 310. In one embodiment, a separate table not shown may be also indexed that stores an indication of whether the PC 310 corresponds to a branch instruction with a branch target instruction located outside region 450. In one embodiment, this indication may include a single bit. When asserted, the prediction logic 360 may predict the corresponding branch target instruction is located outside of region 450. Accordingly, branch target array 368 may be powered up and both arrays 366 and 368 are accessed.

In the embodiment with the indication being a stored single bit, if the bit is not asserted, the prediction logic may predict the corresponding branch target instruction is located within region 450. Accordingly, branch target array 368 may remain powered down and array 366 is accessed. In examples with three or more branch target arrays utilized in prediction logic 360, two or more stored bits may be used to determine the location of a particular branch target instruction. For example, referring again to FIG. 4, if a third region not shown that is larger than region 460 is utilized, then 2 stored bits may be used to identify the location of a branch target instruction. In one embodiment, a binary value of b′00 may indicate a branch target instruction is located within region 450. A binary value of b′01 may indicate the branch target instruction is located outside of region 450, but within region 460. A binary value of b′10 may indicate the branch target instruction is located outside of regions 450 and 460, but within the third larger region.

It is noted that a branch target instruction located outside of the largest region may not have a corresponding stored branch target address. For example, if three regions are utilized, such as region 450, region 460, and a third larger region, branch target instructions located outside of the third larger region may not have a corresponding stored branch target address. No branch target array stores this corresponding address. Thus, the predicted branch target address may be treated as if it is stored in the largest region. Accordingly, this predicted address value is incorrect and will cause a misprediction to be detected in a later clock cycle. However, this case may correspond to a small fraction of the branch target instructions of a software application, and the resulting misprediction penalty may not significantly reduce system performance.

For entries in each of the branch target arrays 366 and 368, two or more branch instructions may access a given entry, and accordingly create conflicts, if the entries are not stored on a per-branch basis. In one embodiment, the address values stored in branch target array 366 may alternatively be placed in a storage that is accessed on a per-branch basis. Therefore, conflicts during access may occur only for a smaller fraction of branch instructions that have corresponding branch target addresses stored in array 368 or in arrays corresponding to regions larger than region 460.

In such an embodiment, this alternative storage may continue to be located within prediction logic 360, but the design of array 366 may change. For example, array 366 may be a cache with cache lines corresponding to cache lines in the i-cache 102. Both the i-cache 102 and array 366 may be indexed by the address stored in PC 310. Alternatively, array 366 may be located outside of prediction logic 360. Such an embodiment is described next.

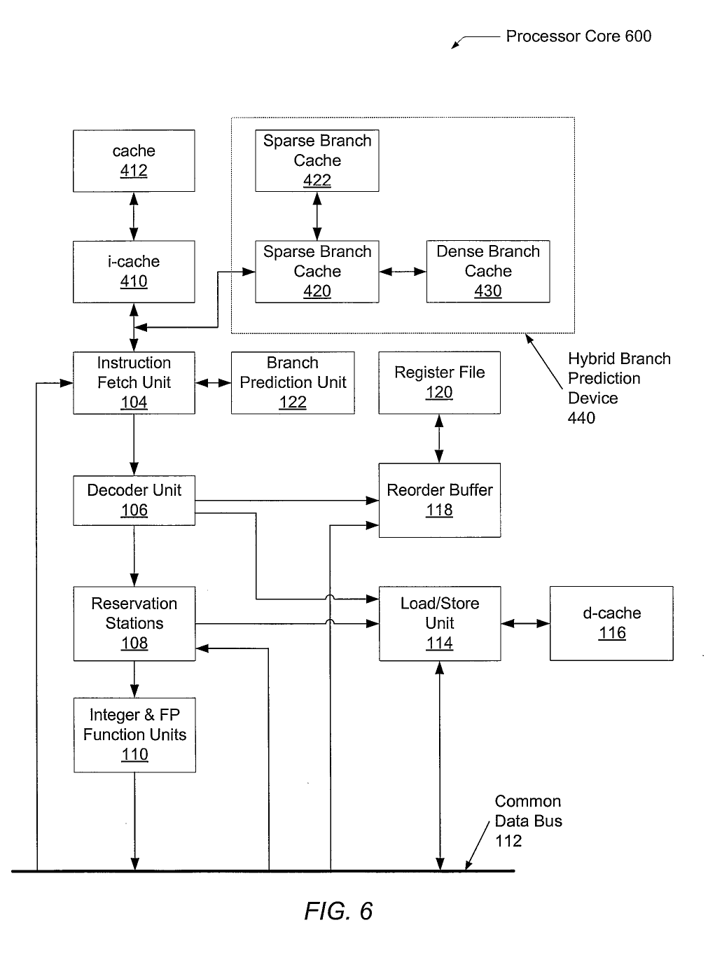

Turning next to FIG. 6, a generalized block diagram of one embodiment of a processor core 600 with hybrid branch prediction is shown. Circuit portions that correspond to those of FIG. 1 are numbered identically. The first two levels of a cache hierarchy for the i-cache subsystem are explicitly shown as i-cache 410 and cache 412. The caches 410 and 412 may be implemented, in one embodiment, as an L1 cache structure and an L2 cache structure, respectively. In one embodiment, cache 412 may be a split second-level cache that stores both instructions and data. In an alternate embodiment, cache 412 may be a shared cache amongst two or more cores and requires a cache coherency control circuit in a memory controller. In other embodiments, an L3 cache structure may be present on-chip or off-chip, and the L3 cache may be shared amongst multiple cores, rather than cache 412.

For a useful proportion of addresses being fetched from i-cache 410, only a few branch instructions may be included in a corresponding i-cache line. Generally speaking, for a large proportion of most application code, branches are found only sparsely within an i-cache line. Therefore, storage of branch prediction information corresponding to a particular i-cache line may not need to allocate circuitry for storing information for a large number of branches. For example, hybrid branch prediction device 440 may more efficiently allocate die area and circuitry for storing branch prediction information to be used by branch prediction unit 122. In one embodiment, prediction device 440 may be located outside of prediction unit 122. In another embodiment, prediction device 440 may be located inside of prediction unit 122.

Sparse branch cache 420 may store branch prediction information for a predetermined common sparse number of branch instructions per i-cache line. Each cache line within i-cache 410 may have a corresponding entry in sparse branch cache 420. In one embodiment, a common sparse number of branches may be 2 branches for each 64-byte cache line within i-cache 410. By storing prediction information for only a sparse number of branches for each line within i-cache 410, cache 420 may be greatly reduced in size from a storage that contains information for a predetermined maximum number of branches for each line within i-cache 410. Die area requirements, capacitive loading, and power consumption may each be reduced.

In one embodiment, the i-cache 410 and sparse branch cache 420 may be similarly organized—for example, both may be organized as 4-way set-associative caches. In other embodiments, each of the I-cache 410 and sparse branch cache 420 may be organized differently. All such alternatives are possible and are contemplated. Each entry of sparse branch cache 420 may correspond to a cache line within i-cache 410. Each entry of sparse branch cache 420 may comprise branch prediction information corresponding to a predetermined sparse number of branch instructions, such as 2 branches, in one embodiment, within a corresponding line of i-cache 410. The branch prediction information is described in more detail later, but the information may contain at least a branch target address and one or more out-of-region bits. In alternate embodiments, a different number of branch instructions may be determined to be sparse and the size of a line within i-cache 410 may be of a different size. Cache 420 may be indexed by the same linear address that is sent from IFU 104 to i-cache 410. Both i-cache 410 and cache 420 may be indexed by a subset of bits within the linear address that corresponds to a cache line boundary. For example, in one embodiment, a linear address may comprise 32 bits with a little-endian byte order and a line within i-cache 410 may comprise 64 bytes. Therefore, caches 410 and 420 may each be indexed by a same portion of the linear address that ends with bit 6.

Sparse branch cache 422 may be utilized in core 400 to store evicted lines from cache 420. Cache 422 may have the same cache organization as cache 412. When a line is evicted from i-cache 410 and placed in Cache 412, its corresponding entry in cache 420 may be evicted from cache 420 and stored in cache 422. Alternatively, when an entry in the cache 410 is invalidated, a corresponding entry in cache 420 may be evicted and store in cache 422. In this manner, when a previously evicted cache line is replaced from Cache 412 to i-cache 410, the corresponding branch prediction information for branches within this cache line is also replaced from cache 422 to cache 420. Therefore, the corresponding branch prediction information does not need to be rebuilt. Processor performance may improve due to the absence of a process for rebuilding branch prediction information.

For regions within application codes that contain more densely packed branch instructions, a cache line within i-cache 410 may contain more than a sparse number of branches. Each entry of sparse branch cache 420 may store an indication of additional branches beyond the sparse number of branches within a line of i-cache 410. If additional branches exist, the corresponding branch prediction information may be stored in dense branch cache 430. More information on hybrid branch prediction device 440 is provided in U.S. patent application Ser. No. 12/205,429, incorporated herein by reference in its entirety. It is noted hybrid branch prediction device 440 is one example of providing per-branch prediction information storage. Other examples are possible and contemplated.

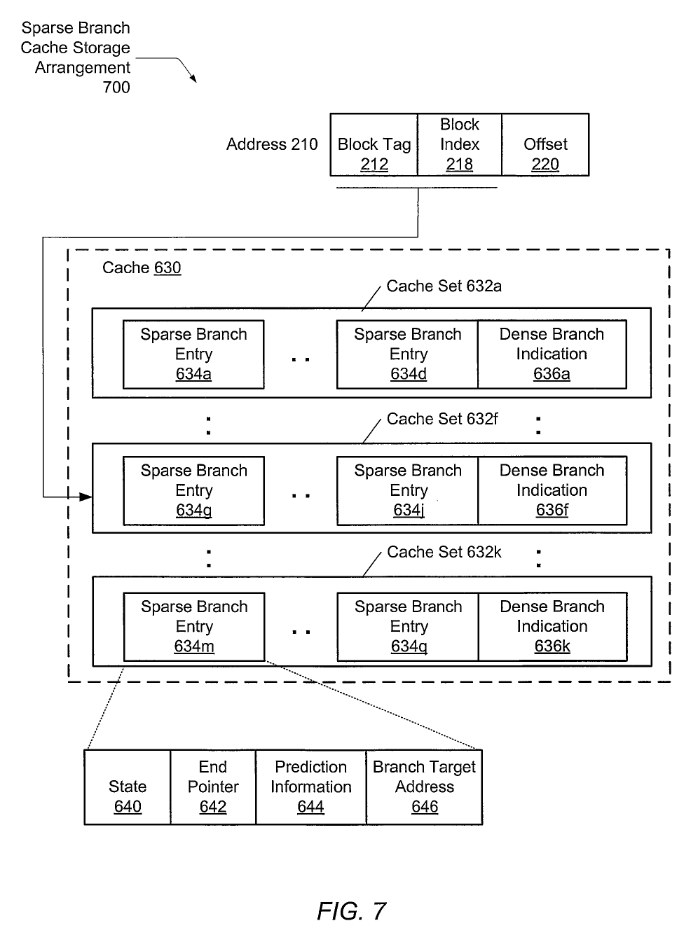

FIG. 7 illustrates one embodiment of a sparse cache storage arrangement 700, wherein branch prediction information is stored. In one embodiment, cache 630 may be organized as a direct-mapped cache. A predetermined sparse number of entries 634 may be stored in the data portion of a cache line within direct-mapped cache 630. In one embodiment, a sparse number may be determined to be 2. Each entry 634 may store branch prediction information for a particular branch within a corresponding line of i-cache 410. An indication that additional branches may exist within the corresponding line beyond the sparse number of branches is stored in dense branch indication 636.

In one embodiment, each entry 634 may comprise a state field 640 that comprises a valid bit and other status information. An end pointer field 642 may store an indication to the last byte of a corresponding branch instruction within a line of i-cache 410. For example, for a corresponding 64-byte i-cache line, an end pointer field 642 may comprise 6 bits in order to point to any of the 64 bytes. This pointer value may be appended to the linear address value used to index both the i-cache 410 and the sparse branch cache 420 and the entire address value may be sent to the branch prediction unit 500.

The prediction information field 644 may comprise data used in branch prediction unit 500. For example, branch type information may be conveyed in order to indicate a particular branch instruction is direct, indirect, conditional, unconditional, or other. Also, one or more out-of-region bits may be stored in field 644. These bits may be used to determine the location on a region-basis of a branch target instruction relative to a corresponding branch instruction as described above regarding FIG. 4.

A corresponding partial branch target address value may be stored in the address field 646. Only a partial branch target address may be needed since a common case may be found wherein branch targets are located within a same page as the branch instruction itself. In one embodiment, a page may comprise 4 KB and only 12 bits of a branch target address may be stored in field 646. A smaller field 646 further aids in reducing die area, capacitive loading, and power consumption. For branch targets that require additional bits than are stored in field 646, a separate out-of-page array, such as array 368, may be utilized.

The dense branch indication field 636 may comprise a bit vector wherein each bit of the vector indicates a possibility that additional branches exist for a portion within a corresponding line of i-cache 410. For example, field 636 may comprise an 8-bit vector. Each bit may correspond to a separate 8-byte portion within a 64-byte line of i-cache 410.

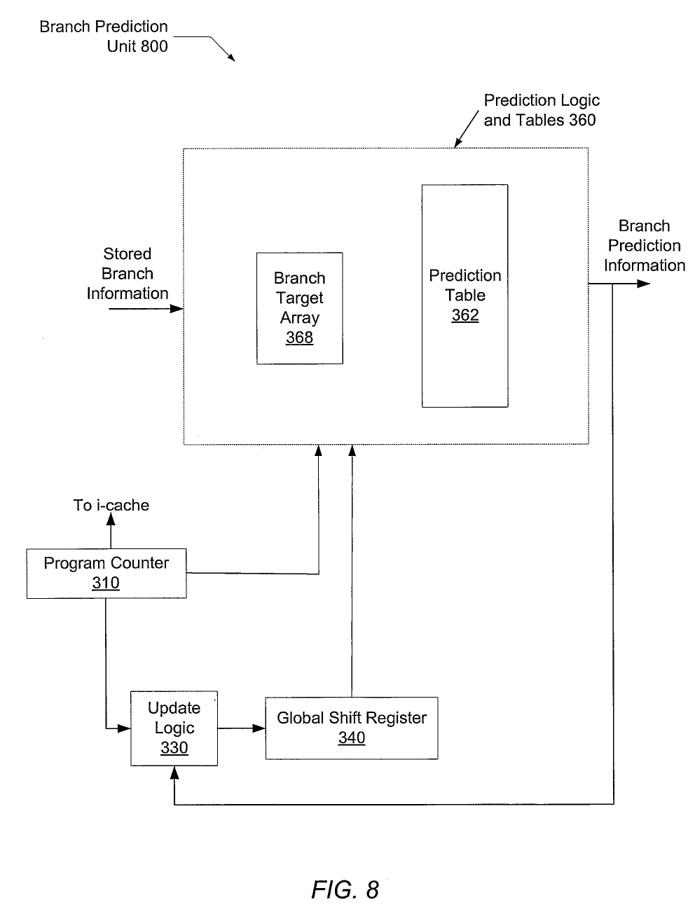

Referring to FIG. 8, one embodiment of a generalized block diagram of a branch prediction unit 800 is shown. Circuit portions that correspond to those of FIG. 5 are numbered identically. Here, stored hybrid branch prediction information may be conveyed to the prediction logic and tables 360. In one embodiment, the hybrid branch prediction information may be stored in separate caches from the i-caches, such as sparse branch caches 420 and 422 and dense branch cache 430. Therefore, conflicts may not occur for a majority of branch instructions in a software application. Array 366 is not used in unit 800, since the corresponding portion of the branch target address and other information is now stored in caches 420-430.

In one embodiment, this information may include a branch number to distinguish branch instructions being predicted within a same clock cycle, branch type information indicating a certain conditional branch instruction type or other, additional address information, such as a pointer to an end byte of the branch instruction within a corresponding cache line, corresponding branch target address information, and out-of-region bits.

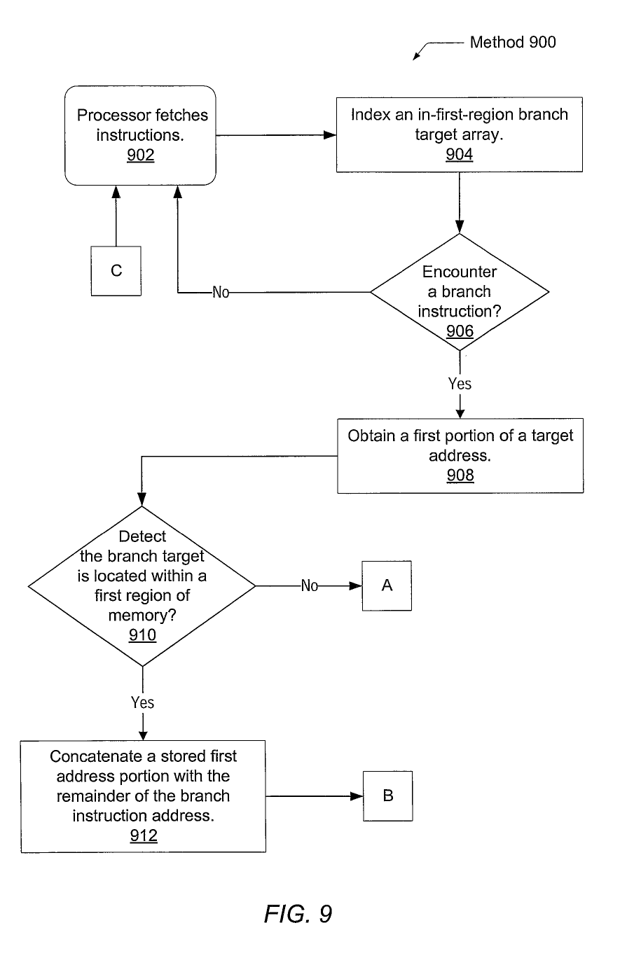

FIG. 9 illustrates a method 900 for efficient branch prediction. Method 900 may be modified by those skilled in the art in order to derive alternative embodiments. Also, the steps in this embodiment are shown in sequential order. However, some steps may occur in a different order than shown, some steps may be performed concurrently, some steps may be combined with other steps, and some steps may be absent in another embodiment. In the embodiment shown, a processor fetches instructions in block 902.

A linear address stored in the program counter may be conveyed to i-cache 410 in order to fetch contiguous bytes of instruction data. Depending on the size of a cache line within i-cache 410, the entire contents of the program counter may not be conveyed to i-cache 410. Also, in block 904, the same address may be conveyed to branch target arrays within branch prediction logic 360. In one embodiment, the same address may be conveyed to a sparse branch cache 420.

If a branch instruction is detected (conditional block 906), then in block 908, a stored first portion of a branch target address is retrieved from the first-region branch target array. In one embodiment, this first portion may be the lower bits of a subset of an entire branch target address, such as the lower 12 bits of a 48-bit address. Then a determination is made whether the corresponding branch target instruction is located within a first region of memory with respect to the branch instruction.

The detection of a branch instruction may include a hit within a branch target array. Alternatively, an indexed cache line within sparse branch cache 420 may convey whether one or more branch instructions correspond to the value stored in PC 310. In one example, one or more out-of-region bits read from a branch target array or sparse branch cache 420 may identify whether a corresponding branch target instruction is located within a first region with respect to the branch instruction. For example, a first region may be an aligned 4 KB page. In one embodiment, a binary value b′0 conveyed by the out-of-region bits may identify the branch target instruction is not located out of the first region, and, therefore, is located within the first region.

If the branch instruction is located within the first region (conditional block 910), then in block 912, the predicted branch target address may be constructed from a stored value and the branch instruction linear address 411. In one embodiment, the lower 12 bits, or bit positions 11:0, of a branch target address may be stored in a branch target array or sparse branch cache 420. A majority of branch target instructions may be located within an aligned 4 KB page of a corresponding branch instruction. The predicted branch target address 440 may be constructed by concatenating the stored 12 bits (positions 11:0) with the upper 36 bits (positions 47:12) of the branch instruction linear address 411. Next, control flow of method 900 moves to block B. If the branch instruction is not located within the first region (conditional block 910), then control flow of method 900 moves to block A.

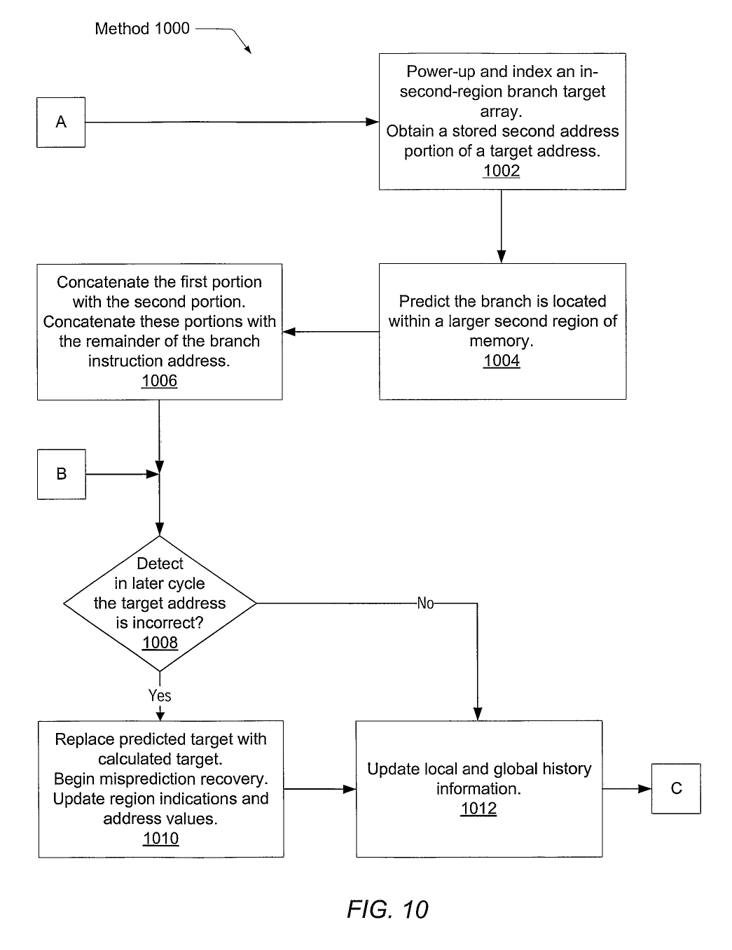

FIG. 10 illustrates a method 1000 for efficient branch prediction. Method 1000 may be modified by those skilled in the art in order to derive alternative embodiments. Also, the steps in this embodiment are shown in sequential order. However, some steps may occur in a different order than shown, some steps may be performed concurrently, some steps may be combined with other steps, and some steps may be absent in another embodiment. In the embodiment shown, block A is reached after a determination is made that a branch target instruction may not be located within a first region of memory as a corresponding branch instruction. In one embodiment, a first region may be an aligned 4 KB page.

In block 1002, a branch target array 368 corresponding to a second region 460 may be powered up. In one embodiment, array 368 may typically be powered down to reduce power consumption. The majority of branch instructions may have a corresponding branch target instruction located within a first region. Therefore, the branch target array 368 may not be accessed for a majority of branch instructions in a software application.

In one embodiment, two regions may be used to categorize the locations of branch target instructions relative to the branch instructions. For example, regions 450 and 460 may be used for this categorization. In other embodiments, three or more regions may be defined and used. In such embodiments, the out-of-region bits may increase in size depending on the total number of regions used. If these bits indicate the branch target instruction is not located within the first to the (n-1)th region, then in block 1004, a prediction may be made that determines the branch target instruction is located in the nth regions. Even if this prediction is incorrect, the fraction of branch instructions mispredicted in this case may be too small to significantly reduce system performance.

In block 1006, in an embodiment with two regions, the predicted branch target address may be constructed from the 12 bits (positions 11:0) stored in a corresponding entry of the branch target array 366 or sparse branch cache 420 with the 16 bits (positions 27:12) stored in a corresponding entry of the array 368 and with the upper remaining bits (positions 47:28) of the branch instruction linear address. Other address portion sizes and branch address sizes are possible and contemplated. Block B is reached when a branch target address is located within the first region. Control flow of method 1000 moves from both block 1006 and block B to conditional block 1008.

In a later clock cycle, if a misprediction of the branch target address is detected (conditional block 1008), then in block 1010, the branch target address is replaced with the calculated value. A misprediction recovery process begins. Included in this process, the address portions stored in the branch target arrays and a sparse branch cache 420 may be updated. In addition, the out-of-region bits may be updated.

If no misprediction is detected (conditional block 1008), then in block 1012, both local and global history information may be updated. Then control flow of method 1000 moves to block C to return to block 902 of method 900 where the processor fetches instructions.

Various embodiments may further include receiving, sending or storing instructions and/or data implemented in accordance with the above description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc.

Although the embodiments above have been described in considerable detail, numerous variations and modifications will become apparent to those skilled in the art once the above disclosure is fully appreciated. It is intended that the following claims be interpreted to embrace all such variations and modifications

What is claimed is:

1. A processor comprising:
a branch prediction unit comprising a plurality of branch target arrays, each branch target array comprising a plurality of entries;
wherein each entry of a first branch target array of the plurality of branch target arrays is configured to store a portion of a branch target address corresponding to a branch instruction, said portion comprising fewer than all bits of the branch target address.

2. The microprocessor as recited in claim 1, wherein the branch prediction unit is further configured to:
store an indication of a location within memory of a branch target corresponding to a given branch instruction; and
construct a predicted branch target address by concatenating a portion of the given branch instruction address with one or more portions of a branch target address stored in a branch target array of the plurality of branch target arrays, wherein the one or more portions are chosen based upon said indication.

3. The microprocessor as recited in claim 2, wherein said indication corresponds to one or more predetermined regions of memory, wherein a first value of said indication indicates a branch target instruction is located within a first region, and an nth value of said indication indicates the branch target instruction is located outside an (n-1)th region but within a larger nth region that encompasses the (n-1)th region, wherein n is an integer greater than 1.

4. The microprocessor as recited in claim 3, wherein a first branch target array corresponds to the first region and an nth branch target array corresponds to the nth region.

5. The microprocessor as recited in claim 4, wherein a bit range of the stored portion of a branch target address in each entry of a given branch target array is non-overlapping with bit ranges of stored portions of other branch target arrays.

6. The microprocessor as recited in claim 5, wherein responsive to a value of said stored indication, said predicted branch target address comprises a concatenation of a portion of the branch address with each stored portion of a branch target array from the first branch target array to an nth branch target array.

7. The microprocessor as recited in claim 4, wherein each entry of the first branch target array is indexed by a branch instruction address.

8. The microprocessor as recited in claim 4, wherein the first branch target array comprises a sparse branch cache comprising a plurality of entries, each of the entries corresponding to an entry of the instruction cache and being configured to:
store branch prediction information for no more than a first number of branch instructions, wherein the information comprises said indication; and
store another indication of whether or not a corresponding entry of the instruction cache includes greater than the first number of branch instructions.

9. A method for branch prediction comprising:
storing a first portion of a branch target address corresponding to a branch instruction in an entry of a first branch target array of a plurality of branch target arrays of a microprocessor;
storing a second portion of a branch target address corresponding to a branch instruction in an entry of a second branch target array of the arrays;
wherein each entry of a first branch target array of the plurality of branch target arrays is configured to store a portion of a branch target address corresponding to a branch instruction, said portion comprising fewer than all bits of the branch target address.

10. The method as recited in claim 9, further comprising:
storing an indication of a location within memory of a branch target corresponding to a given branch instruction; and
constructing a predicted branch target address by concatenating a portion of the given branch instruction address with one or more portions of a branch target address stored in the plurality of branch target arrays, wherein the one or more portions are chosen based upon said indication

11. The method as recited in claim 10, wherein said indication corresponds to one or more predetermined regions of memory, wherein a first value of said indication indicates a branch target instruction is located within a first region, and an nth value of said indication indicates the branch target instruction is located outside an (n-1)th region but within a larger nth region that encompasses the (n-1)th region, wherein n is an integer greater than 1.

12. The method as recited in claim 11, wherein a first branch target array corresponds to the first region and an nth branch target array corresponds to the nth region.

13. The method as recited in claim 12, wherein a bit range of the stored portion of a branch target address in each entry of a given branch target array is non-overlapping with bit ranges of stored portions of other branch target arrays.

14. The method as recited in claim 13, wherein responsive to a value of said stored indication, said predicted branch target address comprises a concatenation of a portion of the branch address with each stored portion of a branch target array from the first branch target array to an nth branch target array.

15. The method as recited in claim 13, wherein a size of the stored portion of a branch target address in each entry of a given branch target array corresponds to a size of the corresponding region of the given branch target array.

16. The method as recited in claim 15, wherein the first branch target array comprises a sparse branch cache comprising a plurality of entries, each of the entries corresponds to an entry of the instruction cache and is configured to:
store branch prediction information for no more than a first number of branch instructions, wherein the information comprises said indication; and
store another indication of whether or not a corresponding entry of the instruction cache includes greater than the first number of branch instructions.

17. A branch prediction unit comprising:
an interface for receiving an address;
a plurality of branch target arrays, each branch target array comprising a plurality of entries; and
wherein each entry of a first branch target array of the plurality of branch target arrays is configured to store a portion of a branch target address corresponding to a branch instruction, said portion comprising fewer than all bits of the branch target address.

18. The branch prediction unit as recited in claim 18, further comprising control logic configured to:
store an indication of a location within memory of a branch target corresponding to a given branch instruction; and
construct a predicted branch target address by concatenating a portion of the given branch instruction address with one or more portions of a branch target address stored in the plurality of branch target arrays, wherein the one or more portions are chosen based upon said indication.

19. The branch prediction unit as recited in claim 18, wherein said indication corresponds to one or more predetermined regions of memory, wherein a first value of said indication indicates a branch target instruction is located within a first region, and an nth value of said indication indicates the branch target instruction is located outside an (n-1)th region but within a larger nth region that encompasses the (n-1)th region, wherein n is an integer greater than 1.

20. The branch prediction unit as recited in claim 19, wherein the nth branch target array remains powered down responsive to said indication indicating the branch target instruction is not located outside the (n-1)th region.
